(19) United States
(12) Patent Application Publication
(10) Pub. No.: US 2026/0081880 A1
(43) Pub. Date: Mar. 19, 2026

(54) AUTOMATED ADVERSARIAL PERSONA CREATION

(71) Applicant: Dell Products L.P., Round Rock, TX (US)

(72) Inventors: Herberth Birck Fröhlich, Florianópolis (BR); Marcus Vinicius Libardi Pazini, Caxias do Sul (BR); Alexander Eulalio Robles Robles, Valinhos (BR); Alisson Linhares de Carvalho, Aracaju (BR)

(21) Appl. No.: 18/884,797

(22) Filed: Sep. 13, 2024

(51) Int. Cl. H04L 51/02

(52) U.S. Cl. CPC H04L 51/02

(57) ABSTRACT

Techniques for optimizing the performance of an LLM-based chatbot are disclosed. A service builds an adversarial prompt representative of an adverse user that will be implemented by an LLM. The service builds a persona prompt for an LLM-based chatbot. The service feeds the adversarial prompt to the LLM, resulting in the LLM implementing the adverse user. The service also feeds the persona prompt to the LLM-based chatbot. The service facilitates an interaction between the LLM-based chatbot and the adverse user. The service causes the adverse user to assign a grade to a performance of the LLM-based chatbot. The service provides, as input, a grading definition and the grade of the LLM-based chatbot to an objective function tasked with determining whether the chatbot's performance was satisfactory. If not satisfactory, an optimization process is triggered.

### COPYRIGHT AND MASK WORK NOTICE

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### TECHNOLOGICAL FIELD OF THE DISCLOSURE

Embodiments disclosed herein generally relate to optimizing an LLM-based chatbot. More particularly, at least some embodiments relate to systems, hardware, software, computer-readable media, and methods for optimizing an LLM-based chatbot to improve its performance with respect to implementing human-like characteristics.

### BACKGROUND

In recent years, the use of chatbots for interactions between companies and clients has become standard practice in many services. However, in the past few years, large language models (LLMs) have revolutionized this field with their capability of providing generalized answers for almost all types of questions. In the artificial intelligence (AI) community, the benefits of using these types of models are many, but they also have limitations.

Although LLMs are becoming more accessible in many business areas, one limitation stands out the most. This limitation relates to the inability of LLM-based chatbots to provide a more “human-like” and engaging experience. This inability is relevant given that in certain domains (e.g., such as retail, customer support, sales, and personnel training), a tailored experience capable of engaging the user is highly desirable.

To solve this problem, an LLM is often instructed to perform a certain role, changing the way the model answer and interacts. This perceived role is called an LLM's “persona.” Without this specific type of instruction (made via prompting), the model will likely produce conversations that do not accurately mimic human-human interactions, leading to frustrating user experiences.

Even though persona creation for human-like responses and desirable behavior from LLMs is a well-known practice in the LLM community, designing specific personas is labor-intensive and relies on the skills of humans creating them. Updating the way an LLM acts is resource consuming as well. Thus, if enough personas are needed to supply an enriching customized user experience, the time-to-market of this service can become slow or expensive due to the amount of human labor that goes into fine tuning every persona prompt. Also, there is no guarantee that the crafted persona will be successful in its mission.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 illustrates an example computing architecture for optimizing an LLM-based chatbot.

FIG. 2 illustrates an adversarial framework.

FIG. 3 illustrates a table of characteristics for an LLM-based chatbot.

FIG. 4 illustrates aspects of a dataset.

FIG. 5 illustrates an adversarial prompt.

FIG. 6 illustrates a persona prompt.

FIG. 7 illustrates an evaluation template.

FIG. 8 illustrates an example of data pertaining to an objective function.

FIGS. 9A, 9B, and 9C illustrate an iterative optimization process.

FIG. 10 illustrates a flowchart of an example method for optimizing an LLM-based chatbot.

FIG. 11 illustrates an example computer system that can be configured to perform any of the disclosed operations.

### DETAILED DESCRIPTION

The disclosed embodiments aim to provide an automated way for fine-tuning/adapting a “macro-persona,” which is considered to be the general orientation of the LLM (particularly for an LLM-based chatbot). This fine-tuning is performed by enriching the macro-persona with user specific log data, thereby creating a “specified persona.” This specified persona is built using an adversarial technique and ultimately behaves in a way that is more assertive to meet user needs, thereby leading to an overall more engaging experience.

For an adversarial technique to take place, the embodiments first use logs of past user interactions where a user has not achieved an end goal (e.g., such as not completing a purchase or failing in having a demand fulfilled in customer support). On the other hand, a macro-persona related to an LLM-based chatbot, whose role is being optimized, is input with positive interactions. In this manner, the embodiments simulate the worst-case interaction scenario for the LLM-based chatbot.

Next, the macro-persona (implemented by the LLM-based chatbot) will interact with the adversarial user (implemented by an LLM) trying to complete its mission. After that, the conversation log will be evaluated by the LLM on certain characteristics that the LLM-based chatbot is supposed to implement. A determined score of the LLM-based chatbot's persona will then be used, together with a metaheuristic, to find the best possible set of persona traits that maximize the LLM-based chatbot's performance for the current task over a predefined number of iterations or whenever a maximum score is obtained.

The disclosed embodiments bring about numerous benefits, advantages, and practical applications in machine learning. For instance, persona-based chatbots with LLMs are well-known concepts. There are several ways to instruct an LLM-based chatbot to mimic the style and tone of a human. The simplest and most popular way involves prompt engineering, where the persona is defined by detailed prompts with a name, objective, background, and communication style. However, researchers have pointed out that more sophisticated strategies are more effective for simulating human behavior. For example, training agents using complete curated individual profiles and narratives, such as life stories, relationships with parents, friends, and family members, allow for richer and more consistent human responses. Other techniques focus on fine-tuning models, such as by embedding human personality in the LLM at the expense of computational power and a large volume of data.

The disclosed techniques beneficially diverge from those existing practices by employing an adversarial strategy to optimize the characteristics of the persona performing a given role. That is, the embodiments beneficially utilize past user logs, a mission, and adversarial techniques to automate the task of persona generation. In doing so, the embodiments improve how LLM personas are generated. Accordingly, these and numerous other benefits will now be described in more detail throughout the remaining portions of this disclosure.

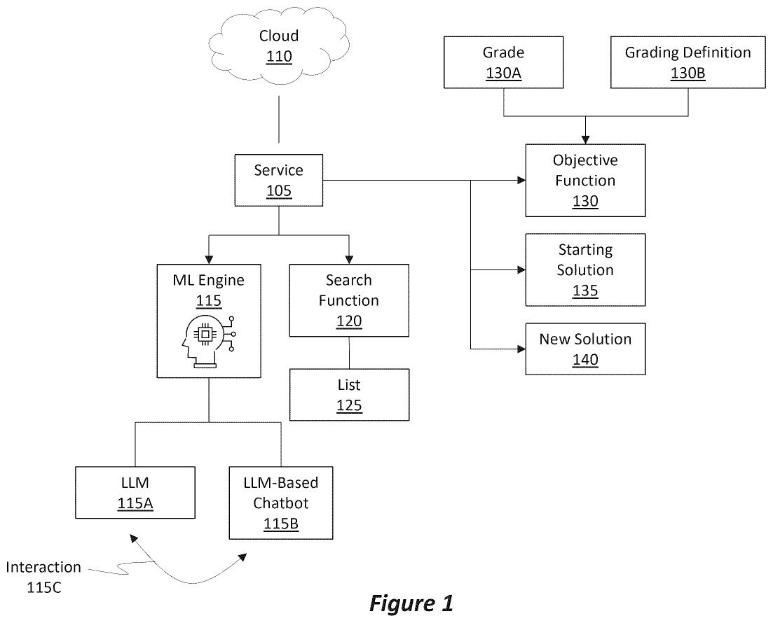

Attention will now be directed to FIG. 1, which illustrates an example architecture 100 in which the disclosed principles may be employed. Architecture 100 shows a service 105.

As used herein, the term “service” refers to an automated program that is tasked with performing different actions based on input. In some cases, service 105 can be a deterministic service that operates fully given a set of inputs and without a randomization factor. In other cases, service 105 can be or can include a machine learning (ML) or artificial intelligence engine, such as ML engine 115. The ML engine 115 enables service 105 to operate even when faced with a randomization factor. The ML engine 115 can include or implement a large language model (LLM) 115A. The ML engine 115 can also include or implement an LLM-based chatbot 115B. In some scenarios, the LLM 115A and the LLM-based chatbot 115B rely on a same LLM. In other scenarios, different LLMs are used. As will be discussed in more detail later, an interaction 115C and be facilitated between the LLM 115A and the LLM-based chatbot 115B.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 105 is a local service operating on a local device. In some implementations, service 105 is a cloud service operating in a cloud 110 environment. In some implementations, service 105 is a hybrid service that includes a cloud component operating in the cloud and a local component operating on a local device. These two components can communicate with one another.

Service 105 is generally tasked with facilitating or implementing an optimization procedure to improve the performance of an LLM-based chatbot. In one scenario, the optimization procedure involves the use of a search function 120, such as a Tabu Search.

A Tabu search (TS) is an algorithm designed to search for solutions, which in the scenarios presented herein, are represented by a set of optimal characteristics that optimizes an objective function. To perform the optimization, TS maintains a sequence of solutions (not always optimal) that were previously tried. This list (e.g., shown by list 125) is called a “Tabu list,” and the elements are “Tabu nodes.”

This Tabu list may present a problem in the sense that it can grow indefinitely large as the iterations to find the optimal solution are performed. However, there are several ways to circumvent this problem, and one of them is to define a fixed list length L and an expiration date E. Thus, the list size is fixed, and the solutions are removed from the list whenever their permanence in L exceeds a threshold of iterations. Also, a solution can be added into the Tabu list if its result is better than the current candidate solution (i.e. the best solution found so far). Thus, for performing a TS, it is worthwhile to define 6 procedures.

One procedure involves defining an objective function 130, and providing a grade 130A and a grading definition 130B for the objective function to evaluate. Further details on grade 130A and grading definition 130B will be provided later. A second procedure involves generating a starting solution 135. A third procedure involves using a “move” function m to explore the solution space (e.g., to generate new trial solutions). A fourth procedure involves creating a Tabu list (e.g., list 125) to store past solutions that are not be repeated. A fifth procedure involves evaluating a new solution 140. A sixth procedure involves storing the new solution 140 in the current solution variable of the list 125.

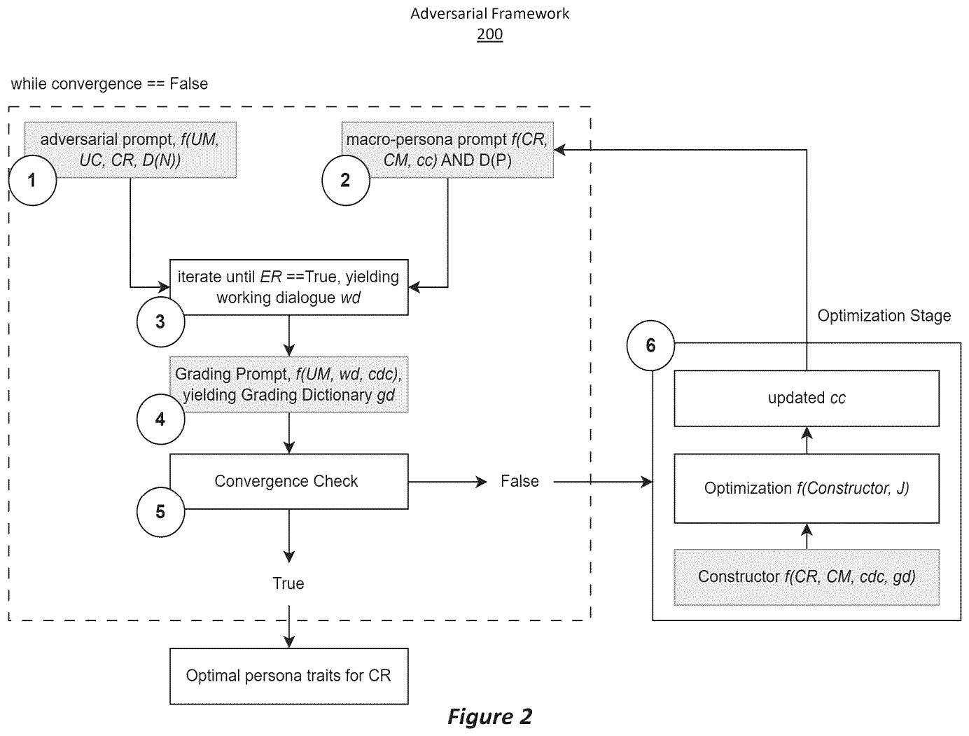

FIG. 2 provides additional details regarding the operations of service 105. In particular, FIG. 2 illustrates an overview of the adversarial framework 200 for the persona characteristics optimization.

Each framework stage is respectively related to the next sections/stages heading number (e.g., heading numbers 1, 2, 3, 4, 5, and 6). Each module with gray color represents an LLM request. It can be assumed that all prompt building, requests, and parsing to retrieve the answers from the LLM output is correctly done, and the LLM is suitable for the process.

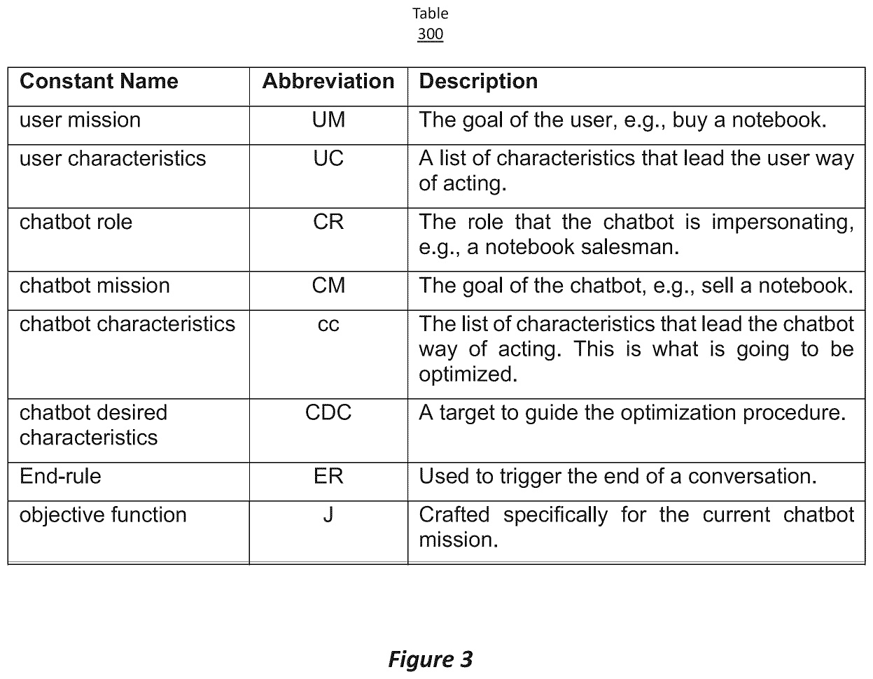

In FIG. 3, table 300 outlines some of the parameters used to run the adversarial framework 200 of FIG. 2, together with their abbreviations and descriptions. Constants are in upper case, and variables are in lower case. In some scenarios, a subject matter expert can fill the table with the parameters. In other scenarios, the ML engine 115 of FIG. 1 can be used to intelligently fill in the parameters.

Notice that one may argue that if the intent is to maximize the score of the attributes, a simple (i.e. naive) solution that does not require a search for optimal attributes is simply to set the chatbot characteristics (cc) with the same traits that the chatbot will be evaluated on (i.e. the desired chatbot characteristics (CDC)). There are various reasons as to why that solution is not ideal.

One reason is that LLMs are often hard to predict. Another reason builds on the idea that LLMs are non-deterministic. In particular, inserting a set of characteristics might force the model to behave closely as intended, but it will not assure a desired behavior. Another reason is that the use of multiple parameters in the objective function may cause the use of the naïve solution to maximize only one part of the expression, thus there might be a solution that is better at improving both terms, making the search for other options a valid method.

Returning to FIG. 2, service 105 first starts with a dataset. To build a simulated adversarial user (e.g., as shown in stage 1 of FIG. 2), service 105 assumes that there is a real dataset D of chats stored during past interactions done by a business and a customer. This dataset is composed of information determined to be relevant for the current scenario. For example, if the objective is to design an adversarial user to tune a chatbot for better handling after-sales customer demands, the data provided for the creation of the adversarial user includes logs from chats between customer-service employees and customers that reflect these situations. The adversarial prompt will be input to an LLM, which will then be tasked to take on the role of the adversarial user.

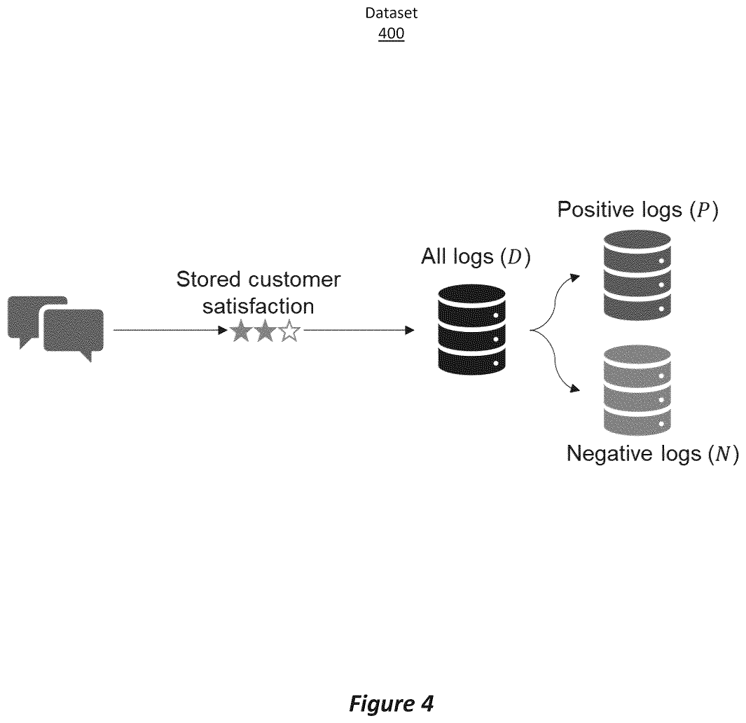

Service 105 can also assume that these logs are labeled according to user satisfaction surveys. Thus, the final datasets will be named P and N, where the P represent logs from D which received positive feedback from customers and N are the logs of negative feedback. A scheme of the dataset is depicted in FIG. 4, as shown by dataset 400, which includes the positive logs (P) and the negative logs (N).

Returning to FIG. 2, with the dataset being filtered and labeled, the next step (stage 2) involves service 105 using the logs as information to generate a persona prompt that will act as a proxy for an adversarial user. Service 105 performs this stage via prompt engineering using a few-shot technique. Other techniques can be used, however, to create this synthetic user, such as a zero-shot technique or even fine-tuning an LLM's weights to incorporate this persona. The persona prompt will be input to an LLM-based chatbot, which will then be tasked to interact with the adversarial user (implemented by the LLM mentioned above).

The adversarial prompt description is illustrated in the below equation. Regardless of whatever method is chosen, there are some elements that are incorporated:

$$adversarialUserPrompt = f ( UM , UC , CR , D ( N ) )$$

The prompt includes a UM (i.e. “User Mission”), UC (i.e. “User Characteristics”), CR (i.e. “Chatbot Role”), and D(N) (i.e. k negative interactions from the dataset). The latter can be incorporated in a few-shot manner. The remaining of the prompt can be left to the user to be filled.

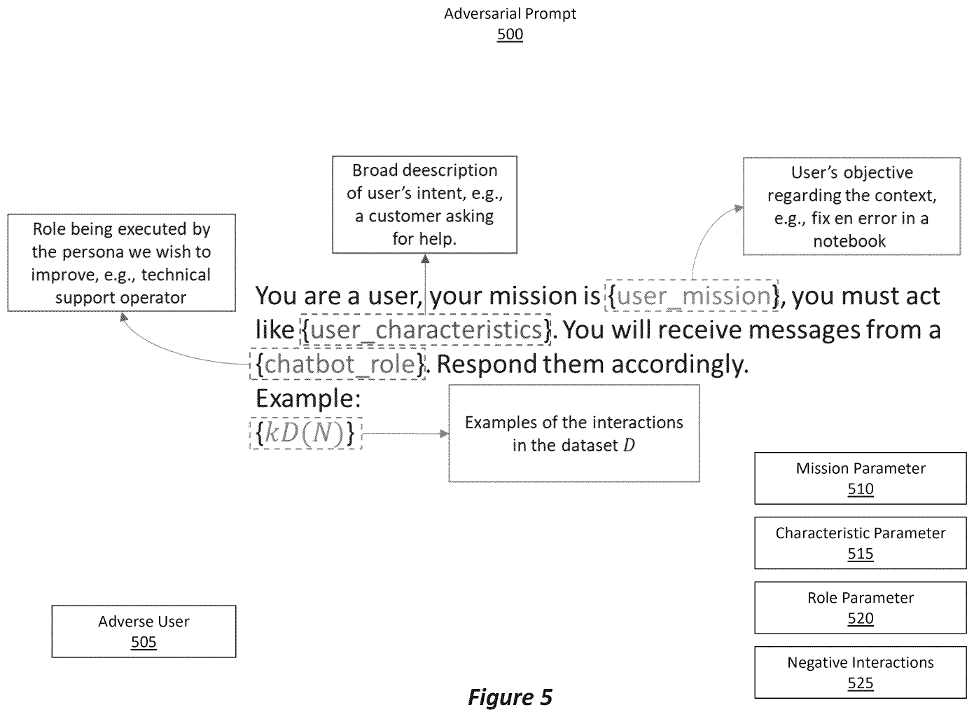

FIG. 5 shows an example of how to build an adversarial prompt 500 configured in the manner described above. In FIG. 5, adversarial prompt 500 can be structured to ensure that the adversarial customer (e.g., adversarial user 505) will behave closer to the worst customers to hopefully produce realistic dialogues and situations. The adversarial prompt 500 can include a mission parameter 510, a characteristic parameter 515, a role parameter 520, and a set of interactions that are classified as negative interactions 525. These are the parameters used to configure the LLM.

It should be noted how the macro-persona is a persona with characteristics that are going to change during the run. Consequently, it is preferable to reserve a shorter amount of time to create the characteristics of the persona's prompt as it is the optimization procedure's goal to search for the optimum characteristics necessary to obtain a chatbot that behaves accordingly. The prompt parameters for the macro persona are as follows:

$$macroPersonaPrompt = f ( CR , CM , cc , D ( P ) )$$

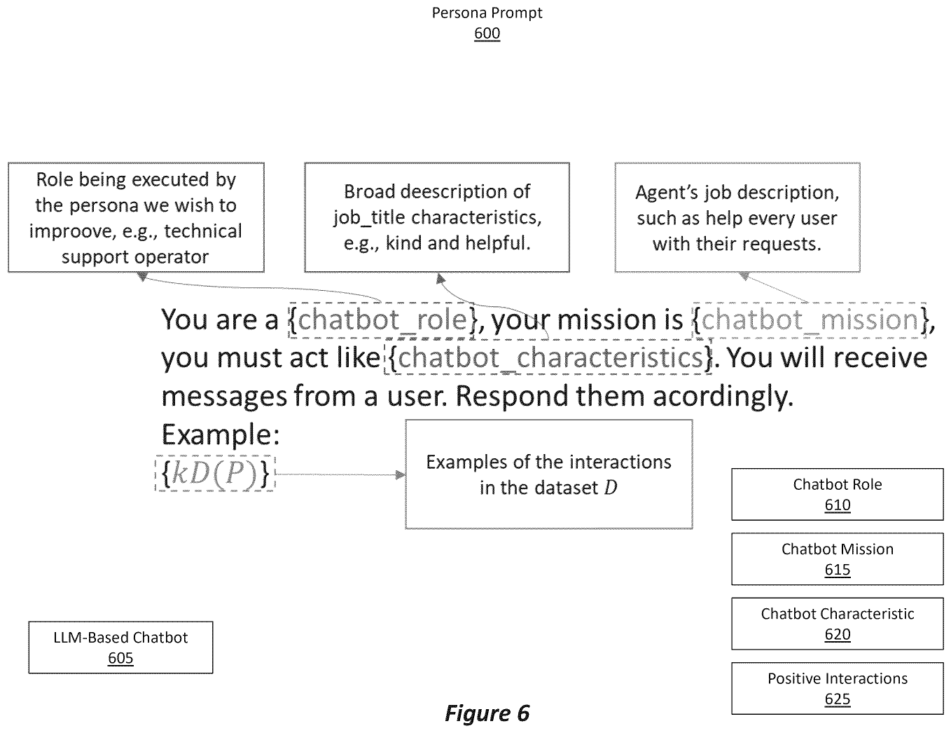

It is expected CR (i.e. “Chatbot Role”), CM (i.e. “Chatbot Mission”), cc (i.e. “Chatbot Characteristics”), and D(P) (i.e. K positive interactions come from the dataset) are included as a part of the prompt. These are the characteristics that will be used to configure the LLM-based chatbot. Recall, the {chatbot characteristics} is what is going to be optimized. FIG. 6 has an example of a persona prompt 600 with the described elements used for the LLM-based chatbot 605. In particular, the persona prompt 600 can include a chatbot role 610, a chatbot mission 615, a chatbot characteristic 620, and a set of interactions that are classified as positive interactions 625.

Returning to FIG. 2, stage 3 shows how one or more rules (ER) can be set to detect if the interaction between the LLM-based chatbot and the adversarial user (implemented by the LLM) has come to an end. The end of interactions can be determined by a regex expression looking for tokens such as “goodbye,” “thanks,” “that will be all for today,” or when the conversation exceeds a threshold number of exchanged messages. The resulting dialogue, including the ending expressions, can be concatenated to produce the working dialogue (wd), which is a labeled conversation (e.g., “User: sentence; Chatbot: sentence; . . . ”), essentially providing a conversation log.

In stage 4, the LLM implementing the adversarial user is asked to fill a form/template grading predetermined aspects of the LLM-based chatbot's performance, as illustrated below.

$$gradingPrompt = f ( UM , wd , CDC )$$

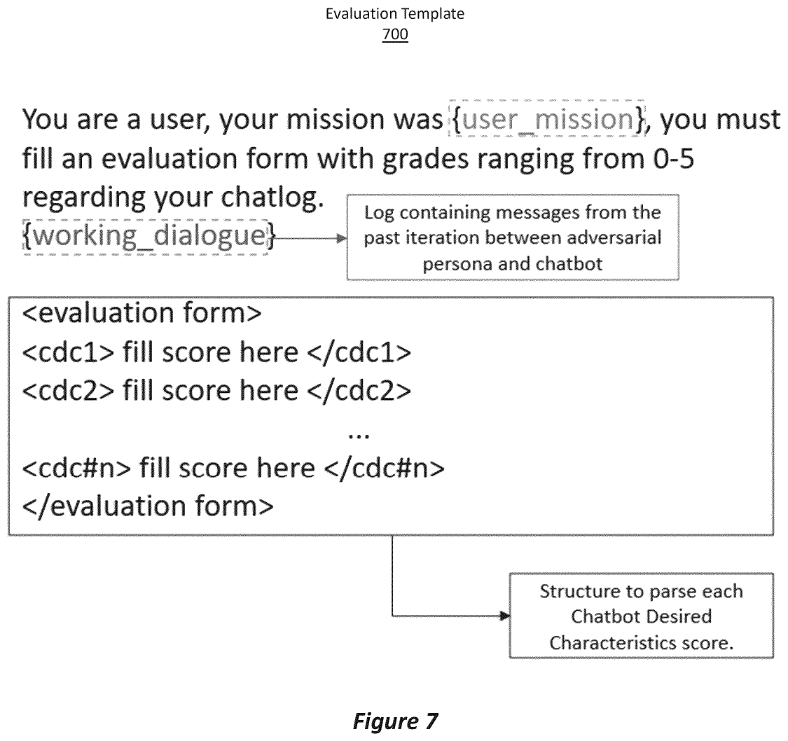

The grading prompt has the following attributes: the user mission, the working dialogue, and the chatbot desired characteristics. The adversarial user can rate the latest dialogue with respect to each CDC. FIG. 7 shows an example of an evaluation template 700 that can be used to perform the evaluation. The output of the evaluation can be in any format that differentiates the grading of each CDC. One example of the output is shown below.

$$g d = \{ {CDC}_{1} : {score}_{cdc 1} , {CDC}_{2} : {score}_{cdc 2} , … {CDC}_{n} : {score}_{cdcn} \} .$$

Returning to FIG. 2, stage 5 shows a convergence check. The convergence check is an algorithm that evaluates the value of an objective function J where the input is the grading dictionary (gd). This objective function can be an average or can be any other metric. When the objective function's value is above a given threshold, the convergence is set to TRUE in FIG. 2, and the ongoing chatbot characteristics (cc) are set as the optimal chatbot characteristics for the LLM-based chatbot. If the value is below the threshold, the adversarial framework 200 proceeds to stage 6 in which a new instance of the optimization procedure refines the ongoing cc in order to improve the score for the next iteration. Thus, stage 6 reflects an optimization procedure.

For the optimization procedure (i.e. stage 6), a metaheuristic will be applied in order to advance the quality of the free parameter (i.e. the chatbot characteristic (cc)) towards a quasi-optimal set of elements that will lead to a better grade for the agent when completing the assigned task. Even though many metaheuristics are suited for this purpose, service 105 can choose (as one example) a discrete optimization method named Tabu Search (TS) due to its simplicity.

In some scenarios, the objective function is represented by metrics derived from the grading dictionary (gd) and can be enhanced by other peculiarities defined by a subject matter expert. For example, if an agent is tasked to perform a sale, a regex expression can be added to find if the adversarial user has agreed in purchasing a product, thus adding points to the objective function to be optimized.

In some implementations, the “newSolutions” part of the original algorithm can be provided by a constructor. Thus, instead of:

$$newSolutions = m ( currentSolution )$$

Service 105 can use:

$$newSolutions = Construct ( CR , CM , cdc , gd )$$

“Construct” is a function that receives as inputs the Chatbot Role, Chatbot Mission, Chatbot desired characteristics, and grading dictionary. With these elements, service 105 can form a prompt to the LLM to generate K new sets of chatbot characteristics (i.e. new solutions). Below is an example of a full prompt.

“Constructor Prompt”

“A {chatbot_role} has been instructed to {chatbot_mission} and it was instructed to behave emulating the flowing {chatbot_characteristics}, it was evaluated by a client that interacted with it and the scores are the following:”

“{Grading_prompt}”

“Suggest K set of characteristics based in the original set that could improve the {chatbot_role} score.”

The newSolutions is an updated instance of cc, which feeds the macro-persona for a new round of interaction towards a convergence and the optimal chatbot characteristics.

### Use Case Example

Now, a specific use case example will be provided. This example embodies the concepts disclosed herein. In this example, a problem is presented, where the problem aims to solve how one could setup the steps of the disclosed techniques and how one would build the improvement loop to obtain the desired refined persona.

In this example, a user contacts a sales representative, which is performed by a persona-based LLM chatbot. The sales representative can give a discount (d) of up to 10% on a product, but the sale representative is instructed to give the smallest possible discount margin during negotiations. Both engage in a conversation with the objective of closing the best deal possible for each of the parties involved.

Here, the adversarial user plays the part of the client and will argue for discounts. The chatbot is the sales representative. The goal for the sales representative, as mentioned above, is to perform a sale while minimizing the discount given.

To start the implementation, service 105 facilitates the definition of the parameters that will be addressed by the methodology. In this example, one parameter relates to defining the following variables: user_mission, user_characteristics, chatbot_role, chatbot_mission, and chatbot_characteristics.

Another parameter relates to the definition of an objective function/that will be maximized. Another parameter relates to the prompts for (i) the adversarial user, (ii) the macro persona, (iii) the grading, and (iv) the constructor prompts.

For this case, the constants and variables can be set as follows:

user_mission: chat with a sales representative and negotiate a discount.

user_characteristics: knowledgeable, frugal, and polite.

chatbot_role: sales representative.

chatbot_mission: close a deal for a product sale offering the smallest possible discount, the maximum possible discount is 10%.

chatbot_characteristics: kind, helpful and persuasive.

chatbot_desired_characteristics: persuasive, empathic, resilient.

Below is an example of the adversarial and macro-persona prompts.

### Adversarial Persona Prompt

“You are a client, your mission is to chat with a sales representative and negotiate a discount. You must act like a knowledgeable, frugal, and polite person. You will receive messages from a sales representative. Respond them accordingly.”

“Example: {Negative examples from the dataset}.”

### Macro Persona Prompt

“You are a sales representative, and your mission is to close a deal for a product sale offering the smallest possible discount, the maximum possible discount is 10%. You must act like a kind, helpful and persuasive person. You will receive messages from a client. Respond them accordingly.”

“Example: {Positive examples from the dataset}.”

The negative examples can be obtained for the adversarial user, and the positive examples can be obtained for the macro persona.

For this embodiment, a subject matter expert (or service 105) can define a set of qualities that the chatbot will be rated on to better perform its function (e.g., sales representative). These qualities include: persuasiveness, empathy, and resilience.

The following is an example of the grading prompt that can be used to obtain the grading dictionary (gd).

### Grading Prompt

“You are a client, your mission was chat with a sales representative and negotiate a discount, you must fill an evaluation form with grades ranging from 0-5 regarding your chatlog.”

“{working_dialogue}.”

“<evaluation form>.”

“<score of persuasiveness> fill score here </score of persuasiveness>.”

“<score of empathy> fill score here </score of empathy>.”

“<score resilience> fill score here </score resilience>.”

“</evaluation form>.”

After the evaluation template is filled with the chatbot_desired_characteristics that are graded, service 105 can use a regex expression to retrieve the score filled by the model so as to form the grading dictionary (gd). The final score (s̅_{f}) is obtained by the average of all attributes obtained from the grading dictionary (gd), e.g.,

$${\overline{s}}_{f} = \frac{1}{3} {\sum }_{i = 1}^{m} {CDC}_{i}$$

(other ways of computing the score such as weighted average are also possible).

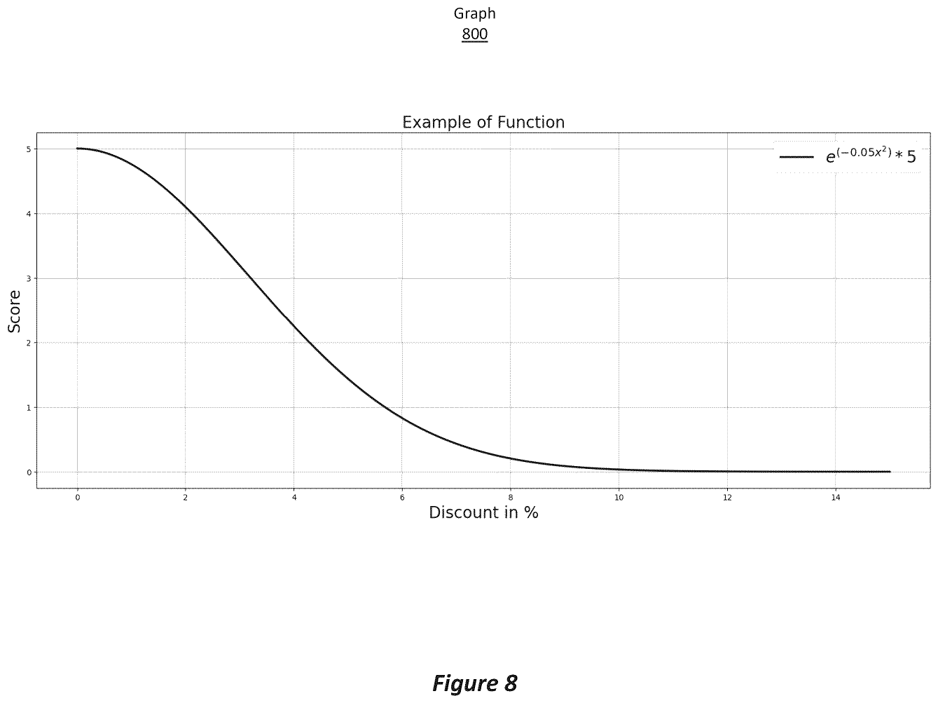

As much as maximizing the s̅_{f} variable can yield a good result in the refinement of the chatbot persona, the agent was instructed to try to minimize the amount of discount given, and the method also allows for the insertion of this restriction to its objective function. To do so, one possibility is to use a regex expression to search for the discount when the interaction ended up with a successful sale and to use a function (e.g., such as an exponential decay function) modulated with coefficients to maximize scores when lesser discounts are given. FIG. 8 presents a graph 800 illustrating an example of such a function.

One can visualize in FIG. 8 how the score for zero discount is the maximum of 5 and gradually decreases to zero for values above 10%. Now, with s̅_{f} and the discount metric, an objective function J with maximum score of 5 and minimum of 0 can be crafted to be used in the optimization procedure. An example of J that encompass this scenario can be:

$$J ( {\overline{s}}_{f} , d ) = \frac{( {\overline{s}}_{f} ) + ( 5 {e}^{- ( 0.05 {x}^{2} )} )}{2}$$

Where [symbol] is an indicator function, i.e., when there is a sale found by the regex, the value of the second term is activated, otherwise the value is zero. The practical implication of this expression is to penalize the score when a sale is not performed, or the discount is greater than 10%.

### Iteration Example

To setup the metaheuristics (Tabu Search) to find the correct chatbot characteristics for maximizing J, service 105 defines the tabu list. In one example, the list can have a maximum size of L=3 and an expiration of E=2 interactions. In other words, after two full iterations, if the method has not converged, the Tabu node is eliminated, and this solution (together with its variations) is allowed again. Usually, the E and L values are larger; however, small numbers are chosen for ease of demonstration.

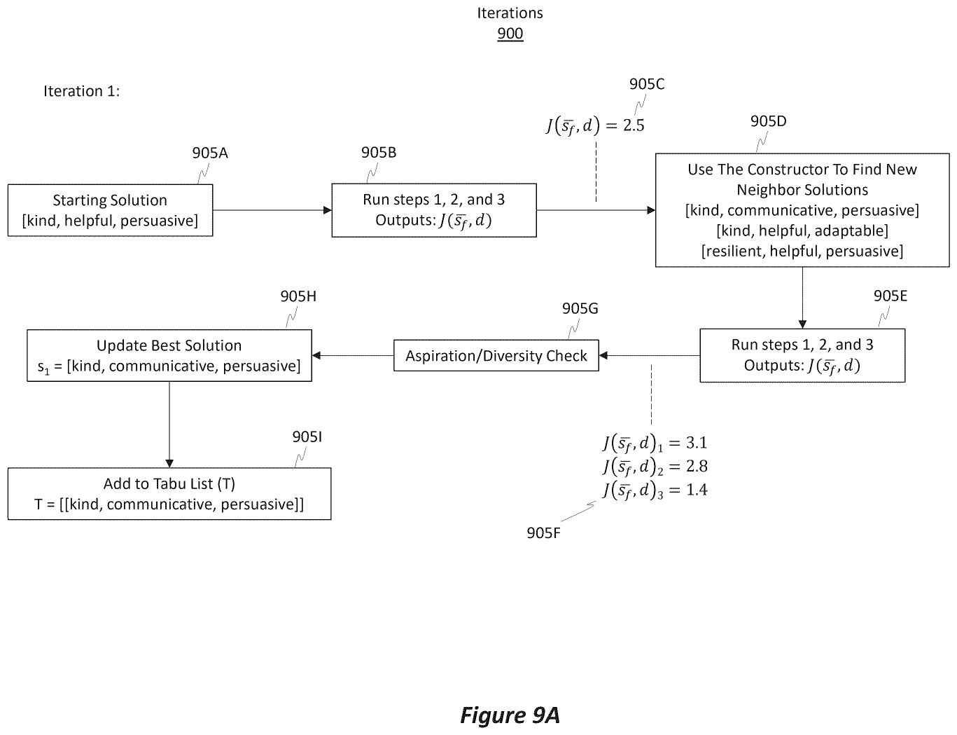

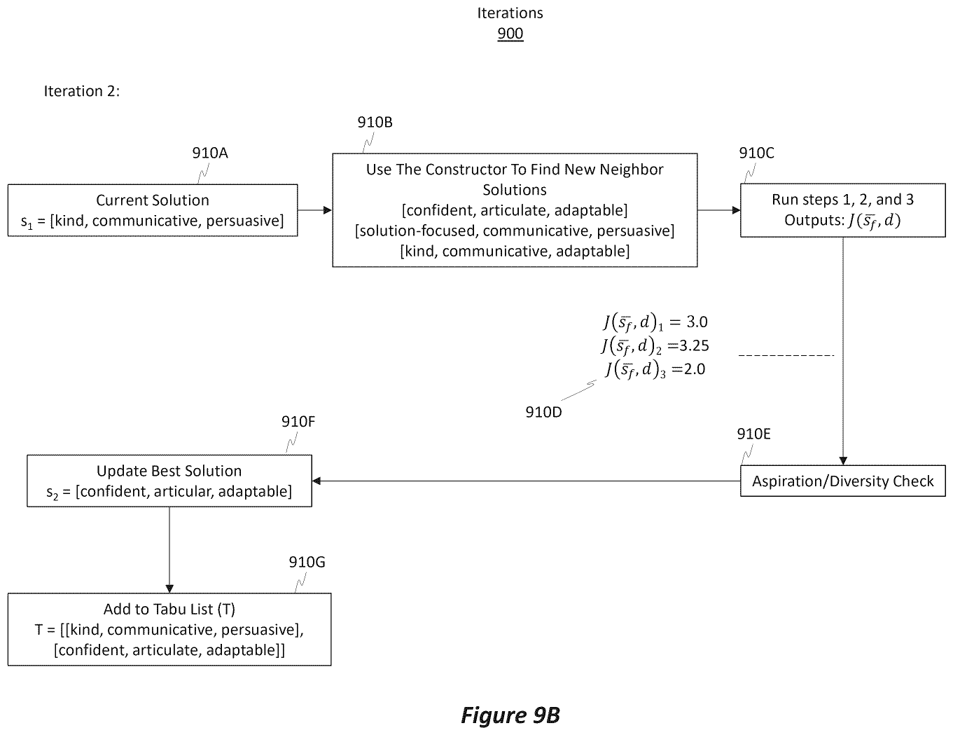

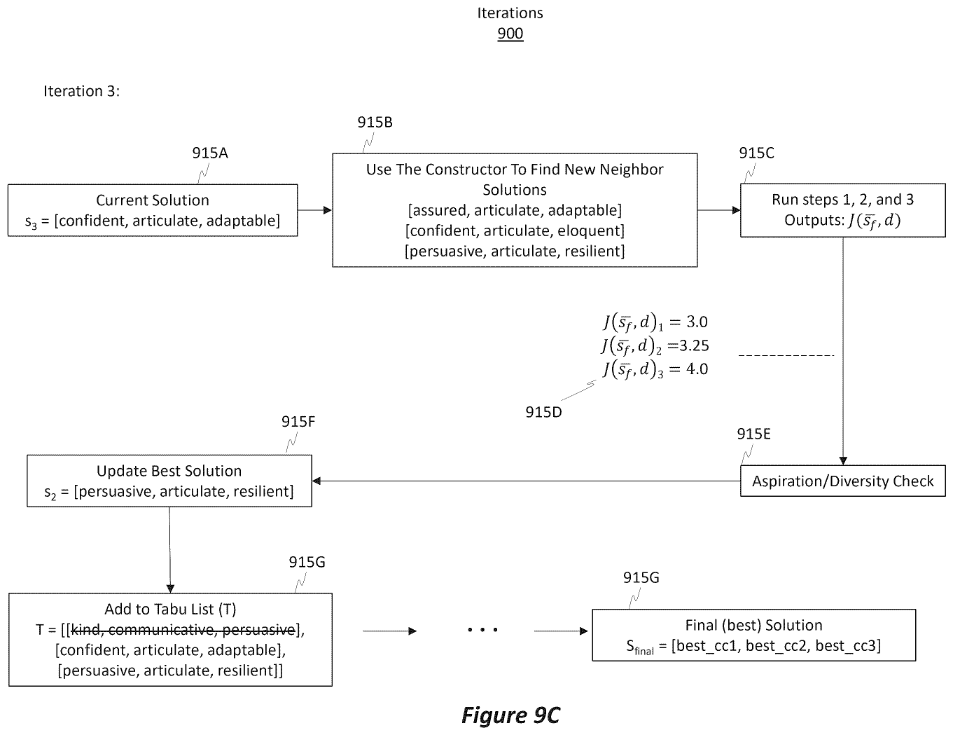

An example of how the iterations are executed is provided in FIGS. 9A, 9B, and 9C. For brevity, every possible situation is not illustrated.

The example of FIGS. 9A, 9B, and 9C is a representation of how the solution runs until the best set of chatbot characteristics is found. FIGS. 9A, 9B, and 9C show that J(s̅_{f}, d) is calculated as an average of the performance of the chatbot, and when a good result is obtained, this result can be selected or discarded given a diversity parameter (i.e. explore solutions different than the one selected at the moment).

After a threshold of iterations is reached (or a good enough solution is found), service 105 considers that the optimization process has ended, and the refined-persona is reached in the form of the optimized chatbot characteristics list: {best_cc₁, best_cc₂, best_cc₃}.

Starting with FIG. 9A, the iterations 900 are illustrated. In iteration 1 (i.e. shown in FIG. 9A), step 905A shows how a starting solution (e.g., [kind, helpful, persuasive]) is provided. In step 905B, stages 1, 2, and 3 from FIG. 2 are run to produce the outputs J(s̅_{f}, d). As shown at 905C, the output J(s̅_{f}, d) is set to the value 2.5.

In step 905D, the constructor is used to find new neighbor solutions (e.g., [kind, communicative, persuasive], [kind, helpful, adaptable], [resilient, helpful, persuasive]). In step 905E, stages 1, 2, and 3 are run again to produce the outputs shows at 905F (i.e. the values 3.1, 2.8, and 1.4). At step 905G, a diversity check is performed to ensure duplicate entries are not being used. At step 905H, the best solution is updated (e.g., s₁= [kind, communicative, persuasive]). At step 905I, the best solution is added to the Tabu list (e.g., T=[[kind, communicative, persuasive]]). Iteration 1 then ends and iteration 2 starts in FIG. 9B.

In iteration 2, step 910A shows the current solution (i.e. s₁=[kind, communicative, persuasive]). In step 910B, the constructor is used to find new neighbor solutions. In step 910C, stages 1, 2, and 3 are run, producing the output values shown in 910D. In step 910E, the diversity check is performed. In step 910F, the best solution is updated. In step 910G, the best solution is added to the Tabu list. Iteration 2 then ends and iteration 3 starts in FIG. 9C.

In iteration 3, step 915A shows the current solution. In step 915B, the constructor is used to find new neighbor solutions. In step 915C, stages 1, 2, and 3 are run, producing the output values shown in 915D. In step 915E, the diversity check is performed. In step 915F, the best solution is updated. In step 915G, the best solution is added to the Tabu list, and one previous solution is removed. Iteration 3 then ends, and any number of subsequent iterations are performed, as shown by the ellipsis. The final (best) solution is then shown in step 915G. Accordingly, FIGS. 9A, 9B, and 9C illustrate the iterative processes that can be performed to determine a best solution.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

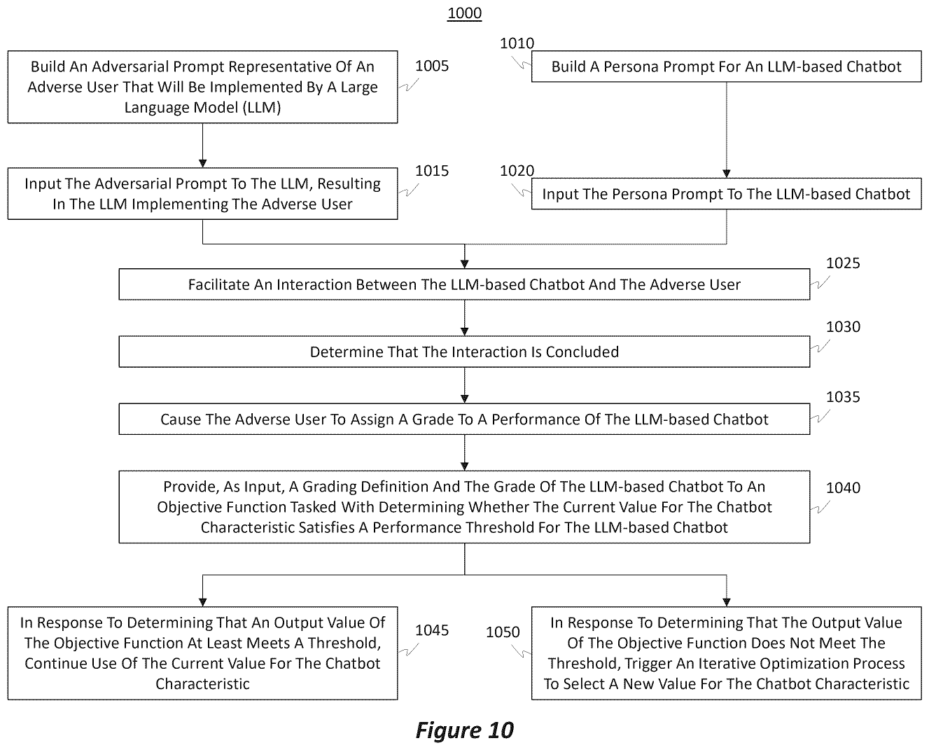

Attention will now be directed to FIG. 10, which illustrates a flowchart of an example method 1000 for optimizing performance of an LLM-based chatbot. Method 1000 can be implemented within architecture 100 of FIG. 1; furthermore, method 1000 can be implemented by service 105. Acts shown in parallel in FIG. 10 can optionally be performed in parallel, concurrently, simultaneously, or in any overlapping manner. They can also be performed sequentially. As such, no particular ordering for the parallel acts is required.

Method 1000 includes an act (act 1005) of building an adversarial prompt (e.g., adversarial prompt 500 of FIG. 5) representative of an adverse user (e.g., adversarial user 505 of FIG. 5) that will be implemented by a large language model (LLM) (e.g., LLM 115A of FIG. 1). The adversarial prompt includes a mission parameter for the adverse user, a characteristic parameter for the adverse user, a role parameter for the adverse user, and a set of interactions that are classified as negative interactions.

Act 1010 includes building a persona prompt (e.g., persona prompt 600 of FIG. 6) for an LLM-based chatbot (e.g., LLM-based chatbot 115B of FIG. 1). The persona prompt includes a chatbot role for the LLM-based chatbot, a chatbot mission for the LLM-based chatbot, a chatbot characteristic for the LLM-based chatbot, and a set of interactions that are classified as positive interactions. As a result of using the set of interactions that are classified as positive interactions for the LLM-based chatbot and as a result of using the set of interactions that are classified as negative interactions for the adverse user, a worst-case scenario is simulated for the LLM-based chatbot.

In one example, the chatbot characteristic for the LLM-based chatbot includes one or more terms describing a particular human characteristic (e.g., kind, sympathetic, etc.) that the LLM-based chatbot is to attempt to portray. The one or more terms can include any number of terms. In one scenario, the terms include at least three different terms.

Act 1015 includes inputting the adversarial prompt to the LLM, resulting in the LLM implementing the adverse user. Act 1020 includes inputting the persona prompt to the LLM-based chatbot. Act 1025 includes facilitating an interaction (e.g., interaction 115C of FIG. 1) between the LLM-based chatbot and the adverse user.

Act 1030 includes determining that the interaction is concluded. Optionally, determining that the interaction is concluded can be based on a predefined set of rules (e.g., the “ER” shown in stage 3 of FIG. 2). As another option, determining that the interaction is concluded can be based on a regex expression searching for a token identified within a log of the interaction.

Act 1035 includes causing the adverse user to assign a grade to a performance of the LLM-based chatbot. The performance is graded based on a current value of the chatbot characteristic. Optionally, the grade of the LLM-based chatbot can be further based on a current value of the chatbot role for the LLM-based chatbot. As another option, the grade of the LLM-based chatbot can be further based on a current value of the chatbot mission for the LLM-based chatbot.

Act 1040 includes providing, as input, a grading definition (e.g., grading definition 130B of FIG. 1) and the grade (e.g., grade 130A) of the LLM-based chatbot to an objective function. The objective function is tasked with determining whether the current value for the chatbot characteristic satisfies a performance threshold for the LLM-based chatbot. Optionally, the grading definition and the grade can be included in a grading prompt that is input to the LLM to grade the LLM-based chatbot.

In response to determining that an output value of the objective function at least meets a threshold, act 1045 includes continuing use of the current value for the chatbot characteristic.

On the other hand, in response to determining that the output value of the objective function does not meet the threshold, act 1050 includes triggering an iterative optimization process to select a new value (e.g., new solution 140 of FIG. 1) for the chatbot characteristic. The optimization process is illustrated in FIGS. 9A, 9B, and 9C.

In some implementations, the optimization process includes maintaining a list (e.g., the Tabu list mentioned earlier) of one or more values for the chatbot characteristic. Optionally, the new value that is selected is determined, as a result of performing the optimization process, to be a particular value that will enable the LLM-based chatbot to operate in a manner such that the output value of the objective function will at least meet the threshold.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. Also, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, client, engine, agent, services, and component are examples of terms that may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

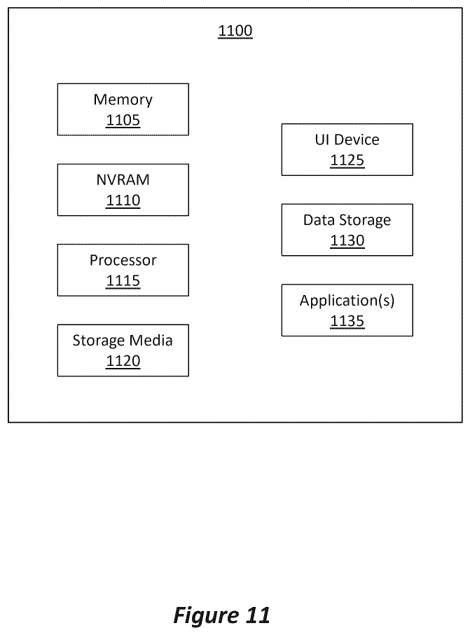

With reference briefly now to FIG. 11, any one or more of the entities disclosed, or implied, by the Figures and/or elsewhere herein, may take the form of, or include, or be implemented on, or hosted by, a physical computing device, one example of which is denoted at 1100. Also, where any of the aforementioned elements comprise or consist of a virtual machine (VM), that VM may constitute a virtualization of any combination of the physical components disclosed in FIG. 11.

In the example of FIG. 11, the physical computing device 1100 includes a memory 1105 which may include one, some, or all, of random access memory (RAM), non-volatile memory (NVM) 1110 such as NVRAM for example, read-only memory (ROM), and persistent memory, one or more hardware processors 1115, non-transitory storage media 1120, UI device 1125, and data storage 1130. One or more of the memory 1105 of the physical computing device 1100 may take the form of solid-state device (SSD) storage. Also, one or more applications 1135 may be provided that comprise instructions executable by one or more hardware processors 1115 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein. The physical device 1100 may also be representative of an edge system, a cloud-based system, a datacenter or portion thereof, or other system or entity.

The disclosed embodiments can be implemented in numerous different ways, as described in the various different clauses recited below.

Clause 1. A method comprising: building an adversarial prompt representative of an adverse user that will be implemented by a large language model (LLM), wherein the adversarial prompt includes a mission parameter for the adverse user, a characteristic parameter for the adverse user, a role parameter for the adverse user, and a set of interactions that are classified as negative interactions; building a persona prompt for an LLM-based chatbot, wherein the persona prompt includes a chatbot role for the LLM-based chatbot, a chatbot mission for the LLM-based chatbot, a chatbot characteristic for the LLM-based chatbot, and a set of interactions that are classified as positive interactions; inputting the adversarial prompt to the LLM, resulting in the LLM implementing the adverse user; inputting the persona prompt to the LLM-based chatbot; facilitating an interaction between the LLM-based chatbot and the adverse user; determining that the interaction is concluded; causing the adverse user to assign a grade to a performance of the LLM-based chatbot, wherein the performance is graded based on a current value of the chatbot characteristic; providing, as input, a grading definition and the grade of the LLM-based chatbot to an objective function tasked with determining whether the current value for the chatbot characteristic satisfies a performance threshold for the LLM-based chatbot; in response to determining that an output value of the objective function at least meets a threshold, continuing use of the current value for the chatbot characteristic; and in response to determining that the output value of the objective function does not meet the threshold, triggering an iterative optimization process to select a new value for the chatbot characteristic.

Clause 2. The method of any of the preceding clauses, wherein, as a result of using the set of interactions that are classified as positive interactions for the LLM-based chatbot and as a result of using the set of interactions that are classified as negative interactions for the adverse user, a worst-case scenario is simulated for the LLM-based chatbot.

Clause 3. The method of any of the preceding clauses, wherein the optimization process includes maintaining a list of one or more values for the chatbot characteristic, and wherein the new value that is selected is determined, as a result of performing the optimization process, to be a particular value that will enable the LLM-based chatbot to operate in a manner such that the output value of the objective function will at least meet the threshold.

Clause 4. The method of any of the preceding clauses, wherein determining that the interaction is concluded is based on a predefined set of rules.

Clause 5. The method of any of the preceding clauses, wherein determining that the interaction is concluded is based on a regex expression searching for a token identified within a log of the interaction.

Clause 6. The method of any of the preceding clauses, wherein the grading definition and the grade are included in a grading prompt that is input to the LLM to grade the LLM-based chatbot.

Clause 7. The method of any of the preceding clauses, wherein the grade of the LLM-based chatbot is further based on a current value of the chatbot role for the LLM-based chatbot.

Clause 8. The method of any of the preceding clauses, wherein the grade of the LLM-based chatbot is further based on a current value of the chatbot mission for the LLM-based chatbot.

Clause 9. The method of any of the preceding clauses, wherein the chatbot characteristic for the LLM-based chatbot includes one or more terms describing a particular human characteristic that the LLM-based chatbot is to attempt to portray.

Clause 10. The method of any of the preceding clauses, wherein the one or more terms include at least three different terms.

Clause 11. One or more hardware storage devices that store instructions that are executable by one or more processors to cause the one or more processors to: build an adversarial prompt representative of an adverse user that will be implemented by a large language model (LLM), wherein the adversarial prompt includes a mission parameter for the adverse user, a characteristic parameter for the adverse user, a role parameter for the adverse user, and a set of interactions that are classified as negative interactions; build a persona prompt for an LLM-based chatbot, wherein the persona prompt includes a chatbot role for the LLM-based chatbot, a chatbot mission for the LLM-based chatbot, a chatbot characteristic for the LLM-based chatbot, and a set of interactions that are classified as positive interactions; feed the adversarial prompt to the LLM, resulting in the LLM implementing the adverse user; feed the persona prompt to the LLM-based chatbot; facilitate an interaction between the LLM-based chatbot and the adverse user; determine that the interaction is concluded; cause the adverse user to assign a grade to a performance of the LLM-based chatbot, wherein the performance is graded based on a current value of the chatbot characteristic; provide, as input, a grading definition and the grade of the LLM-based chatbot to an objective function tasked with determining whether the current value for the chatbot characteristic satisfies a performance threshold for the LLM-based chatbot; in response to determining that an output value of the objective function at least meets a threshold, continue use of the current value for the chatbot characteristic; and in response to determining that the output value of the objective function does not meet the threshold, trigger an iterative optimization process to select a new value for the chatbot characteristic.

Clause 12. The one or more hardware storage devices of any of the preceding clauses, wherein, as a result of using the set of interactions that are classified as positive interactions for the LLM-based chatbot and as a result of using the set of interactions that are classified as negative interactions for the adverse user, a worst-case scenario is simulated for the LLM-based chatbot.

Clause 13. The one or more hardware storage devices of any of the preceding clauses, wherein the optimization process includes maintaining a list of one or more values for the chatbot characteristic, and wherein the new value that is selected is determined, as a result of performing the optimization process, to be a particular value that will enable the LLM-based chatbot to operate in a manner such that the output value of the objective function will at least meet the threshold.

Clause 14. The one or more hardware storage devices of any of the preceding clauses, wherein determining that the interaction is concluded is based on a predefined set of rules.

Clause 15. The one or more hardware storage devices of any of the preceding clauses, wherein determining that the interaction is concluded is based on a regex expression searching for a token identified within a log of the interaction.

Clause 16. The one or more hardware storage devices of any of the preceding clauses, wherein the grading definition and the grade are included in a grading prompt that is input to the LLM to grade the LLM-based chatbot.

Clause 17. The one or more hardware storage devices of any of the preceding clauses, wherein the grade of the LLM-based chatbot is further based on a current value of the chatbot role for the LLM-based chatbot.

Clause 18. The one or more hardware storage devices of any of the preceding clauses, wherein the grade of the LLM-based chatbot is further based on a current value of the chatbot mission for the LLM-based chatbot.

Clause 19. The one or more hardware storage devices of any of the preceding clauses, wherein the chatbot characteristic for the LLM-based chatbot includes one or more terms describing a particular human characteristic that the LLM-based chatbot is to attempt to portray.

Clause 20. A computer system comprising: one or more processors; and one or more hardware storage devices that store instructions that are executable by the one or more processors to cause the computer system to: build an adversarial prompt representative of an adverse user that will be implemented by a large language model (LLM), wherein the adversarial prompt includes a mission parameter for the adverse user, a characteristic parameter for the adverse user, a role parameter for the adverse user, and a set of interactions that are classified as negative interactions; build a persona prompt for an LLM-based chatbot, wherein the persona prompt includes a chatbot role for the LLM-based chatbot, a chatbot mission for the LLM-based chatbot, a chatbot characteristic for the LLM-based chatbot, and a set of interactions that are classified as positive interactions; feed the adversarial prompt to the LLM, resulting in the LLM implementing the adverse user; feed the persona prompt to the LLM-based chatbot; facilitate an interaction between the LLM-based chatbot and the adverse user; determine that the interaction is concluded; cause the adverse user to assign a grade to a performance of the LLM-based chatbot, wherein the performance is graded based on a current value of the chatbot characteristic; provide, as input, a grading definition and the grade of the LLM-based chatbot to an objective function tasked with determining whether the current value for the chatbot characteristic satisfies a performance threshold for the LLM-based chatbot; in response to determining that an output value of the objective function at least meets a threshold, continue use of the current value for the chatbot characteristic; and in response to determining that the output value of the objective function does not meet the threshold, trigger an iterative optimization process to select a new value for the chatbot characteristic.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. It should also be noted how any feature recited herein can be combined with any other feature recited herein.

What is claimed is:

1. A method comprising:
building an adversarial prompt representative of an adverse user that will be implemented by a large language model (LLM), wherein the adversarial prompt includes a mission parameter for the adverse user, a characteristic parameter for the adverse user, a role parameter for the adverse user, and a set of interactions that are classified as negative interactions;
building a persona prompt for an LLM-based chatbot, wherein the persona prompt includes a chatbot role for the LLM-based chatbot, a chatbot mission for the LLM-based chatbot, a chatbot characteristic for the LLM-based chatbot, and a set of interactions that are classified as positive interactions;
inputting the adversarial prompt to the LLM, resulting in the LLM implementing the adverse user;
inputting the persona prompt to the LLM-based chatbot;
facilitating an interaction between the LLM-based chatbot and the adverse user;
determining that the interaction is concluded;
causing the adverse user to assign a grade to a performance of the LLM-based chatbot, wherein the performance is graded based on a current value of the chatbot characteristic;
providing, as input, a grading definition and the grade of the LLM-based chatbot to an objective function tasked with determining whether the current value for the chatbot characteristic satisfies a performance threshold for the LLM-based chatbot;
in response to determining that an output value of the objective function at least meets a threshold, continuing use of the current value for the chatbot characteristic; and
in response to determining that the output value of the objective function does not meet the threshold, triggering an iterative optimization process to select a new value for the chatbot characteristic.

2. The method of claim 1, wherein, as a result of using the set of interactions that are classified as positive interactions for the LLM-based chatbot and as a result of using the set of interactions that are classified as negative interactions for the adverse user, a worst-case scenario is simulated for the LLM-based chatbot.

3. The method of claim 1, wherein the optimization process includes maintaining a list of one or more values for the chatbot characteristic, and wherein the new value that is selected is determined, as a result of performing the optimization process, to be a particular value that will enable the LLM-based chatbot to operate in a manner such that the output value of the objective function will at least meet the threshold.

4. The method of claim 1, wherein determining that the interaction is concluded is based on a predefined set of rules.

5. The method of claim 1, wherein determining that the interaction is concluded is based on a regex expression searching for a token identified within a log of the interaction.

6. The method of claim 1, wherein the grading definition and the grade are included in a grading prompt that is input to the LLM to grade the LLM-based chatbot.

7. The method of claim 1, wherein the grade of the LLM-based chatbot is further based on a current value of the chatbot role for the LLM-based chatbot.

8. The method of claim 1, wherein the grade of the LLM-based chatbot is further based on a current value of the chatbot mission for the LLM-based chatbot.

9. The method of claim 1, wherein the chatbot characteristic for the LLM-based chatbot includes one or more terms describing a particular human characteristic that the LLM-based chatbot is to attempt to portray.

10. The method of claim 9, wherein the one or more terms include at least three different terms.

11. One or more hardware storage devices that store instructions that are executable by one or more processors to cause the one or more processors to:
build an adversarial prompt representative of an adverse user that will be implemented by a large language model (LLM), wherein the adversarial prompt includes a mission parameter for the adverse user, a characteristic parameter for the adverse user, a role parameter for the adverse user, and a set of interactions that are classified as negative interactions;
build a persona prompt for an LLM-based chatbot, wherein the persona prompt includes a chatbot role for the LLM-based chatbot, a chatbot mission for the LLM-based chatbot, a chatbot characteristic for the LLM-based chatbot, and a set of interactions that are classified as positive interactions;
feed the adversarial prompt to the LLM, resulting in the LLM implementing the adverse user;
feed the persona prompt to the LLM-based chatbot;
facilitate an interaction between the LLM-based chatbot and the adverse user;
determine that the interaction is concluded;
cause the adverse user to assign a grade to a performance of the LLM-based chatbot, wherein the performance is graded based on a current value of the chatbot characteristic;
provide, as input, a grading definition and the grade of the LLM-based chatbot to an objective function tasked with determining whether the current value for the chatbot characteristic satisfies a performance threshold for the LLM-based chatbot;
in response to determining that an output value of the objective function at least meets a threshold, continue use of the current value for the chatbot characteristic; and
in response to determining that the output value of the objective function does not meet the threshold, trigger an iterative optimization process to select a new value for the chatbot characteristic.

12. The one or more hardware storage devices of claim 11, wherein, as a result of using the set of interactions that are classified as positive interactions for the LLM-based chatbot and as a result of using the set of interactions that are classified as negative interactions for the adverse user, a worst-case scenario is simulated for the LLM-based chatbot.

13. The one or more hardware storage devices of claim 11, wherein the optimization process includes maintaining a list of one or more values for the chatbot characteristic, and wherein the new value that is selected is determined, as a result of performing the optimization process, to be a particular value that will enable the LLM-based chatbot to operate in a manner such that the output value of the objective function will at least meet the threshold.

14. The one or more hardware storage devices of claim 11, wherein determining that the interaction is concluded is based on a predefined set of rules.

15. The one or more hardware storage devices of claim 11, wherein determining that the interaction is concluded is based on a regex expression searching for a token identified within a log of the interaction.

16. The one or more hardware storage devices of claim 11, wherein the grading definition and the grade are included in a grading prompt that is input to the LLM to grade the LLM-based chatbot.

17. The one or more hardware storage devices of claim 11, wherein the grade of the LLM-based chatbot is further based on a current value of the chatbot role for the LLM-based chatbot.

18. The one or more hardware storage devices of claim 11, wherein the grade of the LLM-based chatbot is further based on a current value of the chatbot mission for the LLM-based chatbot.

19. The one or more hardware storage devices of claim 11, wherein the chatbot characteristic for the LLM-based chatbot includes one or more terms describing a particular human characteristic that the LLM-based chatbot is to attempt to portray.

20. A computer system comprising:
one or more processors; and
one or more hardware storage devices that store instructions that are executable by the one or more processors to cause the computer system to:
build an adversarial prompt representative of an adverse user that will be implemented by a large language model (LLM), wherein the adversarial prompt includes a mission parameter for the adverse user, a characteristic parameter for the adverse user, a role parameter for the adverse user, and a set of interactions that are classified as negative interactions;
build a persona prompt for an LLM-based chatbot, wherein the persona prompt includes a chatbot role for the LLM-based chatbot, a chatbot mission for the LLM-based chatbot, a chatbot characteristic for the LLM-based chatbot, and a set of interactions that are classified as positive interactions;
feed the adversarial prompt to the LLM, resulting in the LLM implementing the adverse user;
feed the persona prompt to the LLM-based chatbot;
facilitate an interaction between the LLM-based chatbot and the adverse user;
determine that the interaction is concluded;
cause the adverse user to assign a grade to a performance of the LLM-based chatbot, wherein the performance is graded based on a current value of the chatbot characteristic;
provide, as input, a grading definition and the grade of the LLM-based chatbot to an objective function tasked with determining whether the current value for the chatbot characteristic satisfies a performance threshold for the LLM-based chatbot;
in response to determining that an output value of the objective function at least meets a threshold, continue use of the current value for the chatbot characteristic; and
in response to determining that the output value of the objective function does not meet the threshold, trigger an iterative optimization process to select a new value for the chatbot characteristic.
